(19) United States
(12) Patent Application Publication
(10) Pub. No.: US 2023/0219414 A1
(43) Pub. Date: Jul. 13, 2023

(54) VEHICLE CONTROL DEVICE, VEHICLE CONTROL METHOD, AND NON-TRANSITORY STORAGE MEDIUM ON WHICH A PROGRAM IS STORED

(71) Applicant: TOYOTA JIDOSHA KABUSHIKI KAISHA, Toyota-shi (JP)

(72) Inventors: Hirofumi MORI, Hadano-shi (JP); Vanquyhung NGUYEN, Sunto-Gun (JP)

(21) Appl. No.: 18/057,792

(22) Filed: Nov. 22, 2022

(30) Foreign Application Priority Data
Jan. 11, 2022 (JP) 2022-002489
Mar. 3, 2022 (JP) 2022-032783

(51) Int. Cl. B60K 31/02; B60K 31/00

(52) U.S. Cl. CPC B60K 31/02; B60K 31/0008

(57) ABSTRACT

A vehicle control device includes: a processor, wherein the processor is configured to control a reaction force application mechanism, which applies reaction force to an accelerator pedal, based on a predetermined driving operation by a driver. In this way, not only is the reaction force application mechanism controlled on the basis of the inter-vehicle distance between the host vehicle and the preceding vehicle, but also, the reaction force that is applied to the accelerator pedal is changed while taking a predetermined driving operation by the driver into consideration.

### CROSS-REFERENCE TO RELATED APPLICATION

This application is based on and claims priority under 35 USC 119 from Japanese Patent Application No. 2022-032783 filed on Mar. 3, 2022 and Japanese Patent Application No. 2022-002489 filed on Jan. 11, 2022, the disclosure of which are incorporated by reference herein.

### BACKGROUND

### Technical Field

The present disclosure relates to a vehicle control device, a vehicle control method, and a non-transitory storage medium on which a program is stored.

### Related Art

Japanese Patent Application Laid-Open (JP-A) No. 2003-205760 discloses a driving operation assist device for a vehicle that computes a degree of risk for the periphery of the host vehicle, and in which, the higher the computed degree of risk, the more the reaction force of the accelerator pedal is increased. The driving operation assist device for a vehicle disclosed in JP-A No. 2003-205760 is structured so as to compute the degree of risk on the basis of the inter-vehicle distance from the host vehicle to the preceding vehicle that the host vehicle is following, and the relative speeds of the vehicles.

However, in the device disclosed in JP-A No. 2003-205760, there is the possibility that reaction force will be applied to the accelerator pedal in a situation in which the driver of the host vehicle wishes to overtake the preceding vehicle. Therefore, there is room for improvement in carrying out drive assist without hampering driving.

### SUMMARY

The present disclosure provides a vehicle control device, a vehicle control method, and a non-transitory storage medium on which a program is stored, which can carry out drive assist without hampering driving.

A first aspect of present disclosure is a vehicle control device including: a processor, wherein the processor is configured to control a reaction force application mechanism, which applies reaction force to an accelerator pedal, based on a predetermined driving operation by a driver.

In the vehicle control device of the first aspect, on the basis of a predetermined driving operation by the driver, the processor controls the reaction force application mechanism that applies reaction force to the accelerator pedal. In this way, not only is the reaction force application mechanism controlled on the basis of the inter-vehicle distance between the host vehicle and the preceding vehicle, but also, the reaction force that is applied to the accelerator pedal is changed while taking a predetermined driving operation by the driver into consideration. Due thereto, the application of reaction force to the accelerator pedal can be suppressed in situations such as cases in which the driver wishes to overtake the preceding vehicle, and the like.

In a second aspect of the present disclosure, in the first aspect, the processor may control the reaction force application mechanism so as to effect an applied state in which reaction force is applied to the accelerator pedal in a case in which an inter-vehicle distance in a longitudinal direction between a host vehicle and a preceding vehicle traveling in front of the host vehicle is less than a threshold value, and such that, at a time of a the predetermined driving operation by the driver, the reaction force applied to the accelerator pedal decreases.

In the vehicle control device of the second aspect, reaction force is applied to the accelerator pedal by the reaction force application mechanism in a case in which the inter-vehicle distance in the longitudinal direction between the host vehicle and the preceding vehicle is smaller than a threshold value. Due thereto, the driver can be warned of approaching the preceding vehicle. Further, in the state in which reaction force is being applied, at the time of a predetermined driving operation by the driver, the reaction force application mechanism is controlled such that the reaction force applied to the accelerator pedal decreases. Due thereto, driving is not hampered in cases in which the driver wishes to accelerate. Note that what is called “the reaction force application mechanism is controlled such that the reaction force applied to the accelerator pedal decreases” is a concept that encompasses structures that cancel the state in which reaction force is applied by the reaction force application mechanism.

In a third aspect of the present disclosure, in the second aspect, the processor may control the reaction force application mechanism such that the reaction force applied to the accelerator pedal decreases in a case in which a driving operation relating to acceleration is carried out by the driver.

In the vehicle control device of the third aspect, by decreasing the reaction force of the accelerator pedal in case in which a driving operation relating to acceleration is carried out by the driver, control that takes the intent of the driver into consideration can be carried out, and the comfort can be improved.

In a fourth aspect of the present disclosure, in the third aspect, the processor may determine that the driving operation relating to acceleration is carried out based on a degree of depression of the accelerator pedal.

In the vehicle control device of the fourth aspect, by determining that a driving operation relating to acceleration is carried out on the basis of the degree of opening of the accelerator pedal, such as in a case in which increasing depression of the accelerator pedal is sensed or the like, the reaction force application mechanism can be controlled while reflecting the intent of the driver to accelerate.

In a fifth aspect of the present disclosure, in any one of the first through fourth aspects, the processor may control the reaction force application mechanism such that the reaction force applied to the accelerator pedal decreases in a case in which a driving operation relating to a lane change is carried out by the driver.

In the vehicle control device of the fifth aspect, by decreasing the reaction force of the accelerator pedal in case in which a driving operation relating to a lane change is carried out by the driver, control that takes the intent of the driver into consideration can be carried out, and the comfort can be improved.

In a sixth aspect of the present disclosure, in the fifth aspect, the processor may determine that the driving operation relating to a lane change is carried out based on information regarding a turn signal switch.

In the vehicle control device of the sixth aspect, it can be determined that there is the intent to change lanes in a case in which the turn signal switch is turned on, and the reaction force application mechanism can be controlled while reflecting the intent of the driver to avoid the preceding vehicle.

A seventh aspect of the present disclosure is a vehicle including: a sensor configured to sense a preceding vehicle; a reaction force application mechanism configured to apply reaction force to an accelerator pedal; and the vehicle control device.

In the vehicle of the seventh aspect, due to the preceding vehicle being sensed by the sensor, the inter-vehicle distance between the host vehicle and the preceding vehicle is computed. Further, the reaction force applied to the accelerator pedal can be changed by controlling the reaction force application mechanism on the basis of the computed inter-vehicle distance and a predetermined driving operation by the driver.

An eight aspect of the present disclosure is a vehicle control method including: controlling, based on a predetermined driving operation by a driver, a reaction force application mechanism that applies reaction force to an accelerator pedal.

A non-transitory storage medium on which is stored a program of the ninth aspect is a non-transitory storage medium on which is stored a program executable by a computer to execute processing, the processing including controlling, on the basis of a predetermined driving operation by a driver, a reaction force application mechanism that applies reaction force to an accelerator pedal.

The vehicle control device, vehicle control method, and non-transitory storage medium on which a program is stored relating to the present disclosure, drive assist can be carried out without hampering driving.

### BRIEF DESCRIPTION OF THE DRAWINGS

Exemplary embodiments of the present disclosure will be described in detail based on the following figures, wherein:

FIG. 1 a block drawing illustrating hardware structures of a vehicle relating to an exemplary embodiment;

FIG. 2 is a block drawing illustrating functional structures of a vehicle control device relating to the exemplary embodiment;

FIG. 3 is a schematic drawing illustrating a state in which an host vehicle and a preceding vehicle are traveling in a same lane in the exemplary embodiment;

FIG. 4 is a schematic drawing illustrating a state in which the host vehicle is preparing for a lane change from the state of FIG. 3; and

FIG. 5 is a flowchart illustrating an example of the flow of vehicle control processing in the exemplary embodiment.

### DETAILED DESCRIPTION

A vehicle 10 that includes a vehicle control device 12 relating to an embodiment is described with reference to the drawings.

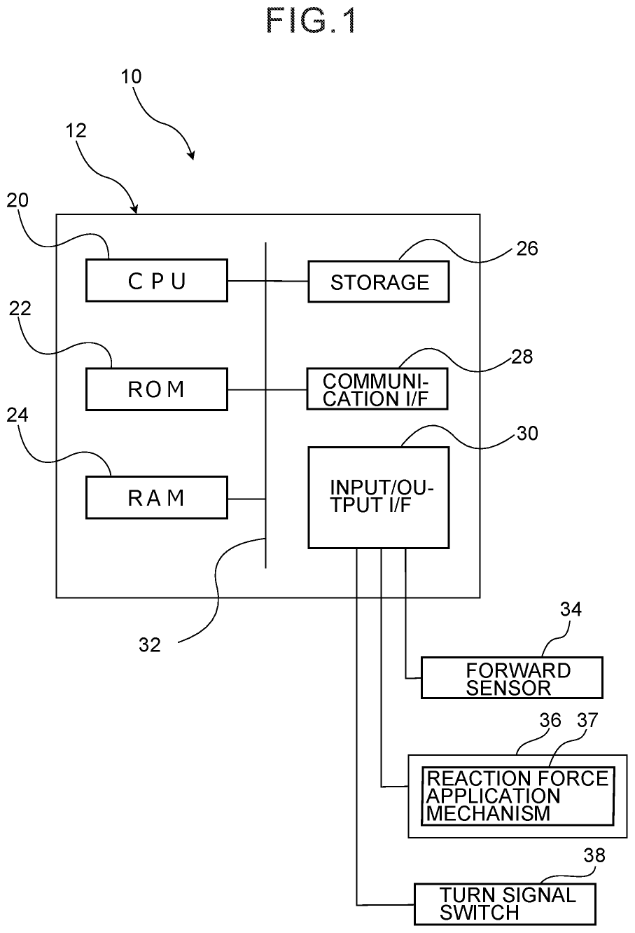

(Hardware Structures of Vehicle 10) FIG. 1 is a block drawing illustrating hardware structures of the vehicle 10. As illustrated in FIG. 1, the vehicle 10 has the vehicle control device 12. The vehicle control device 12 is structured to include a CPU (Central Processing Unit: processor) 20, a ROM (Read Only Memory) 22, a RAM (Random Access Memory) 24, a storage 26, a communication I/F (communication interface) 28, and an input/output I/F (input/output interface) 30. These respective structures are connected so as to be able to communicate with one another through bus 32.

The CPU 20 is a central computing processing unit, and executes various programs and controls the respective sections. Namely, the CPU 20 reads-out programs from the ROM 22 and the storage 26, and executes the programs by using the RAM 24 as a workspace. Further, the CPU 20 carries out control of the above-described respective structures, and various types of computing processing, in accordance with the programs recorded in the ROM 22 and the storage 26.

The ROM 22 stores various programs and various data. The RAM 24 is a non-transitory storage medium that temporarily stores programs and data as a workspace. The storage 26 is a non-transitory storage medium that is structured by an HDD (Hard Disk Drive) or an SSD (Solid State Drive) and that stores various programs, including the operating system, and various data. In the present embodiment, a vehicle control program for carrying out vehicle control processing, and various data, and the like are stored in the storage 26.

The communication I/F 28 is an interface for the vehicle control device 12 to communicate with servers and other equipment. Standards such as, for example, CAN (Controller Area Network), Ethernet®, LTE (Long Term Evolution), FDDI (Fiber Distributed Data Interface), Wi-Fi® and the like are used at the communication I/F 28.

A forward sensor 34, an accelerator pedal 36, and turn signal switches 38 are electrically connected to the input/output I/F 30. The forward sensor 34 is a sensor that can sense obstacles in front of the vehicle, and is structured to include, for example, a camera, radar, LIDAR (Light Detection and Ranging, or Laser Imaging Detection and Ranging) or the like. In particular, in the present embodiment, the forward sensor 34 is used in order to sense a preceding vehicle that travels in front of the host vehicle.

The accelerator pedal 36 is located at the lower portion of the driver's seat, and causes the vehicle 10 to generate propulsive force in accordance with the depressed amount thereof by which the accelerator pedal 36 is depressed by the driver. A stroke sensor that can sense the degree of opening or the depressed amount of the accelerator pedal 36 is provided thereat. The degree of opening of the accelerator pedal 36 is always senses by the stroke sensor.

A reaction force application mechanism 37 is provided at the accelerator pedal 36. The reaction force application mechanism 37 is a mechanism that can apply reaction force to the accelerator pedal, and is structured to include, for example, a servo motor that is connected to the accelerator pedal. Due to the reaction force application mechanism 37 operating, predetermined torque is generated from the servo motor, and, due thereto, an arbitrary reaction force can be applied to the accelerator pedal.

The turn signal switches 38 are switches for turning the winkers (also called turn signals) on, and are provided in a vicinity of the steering wheel. By acquiring signals from the turn signal switches 38, the vehicle control device 12 can sense whether the left and the right turn signal switches 38 are in an on state or in an off state, respectively.

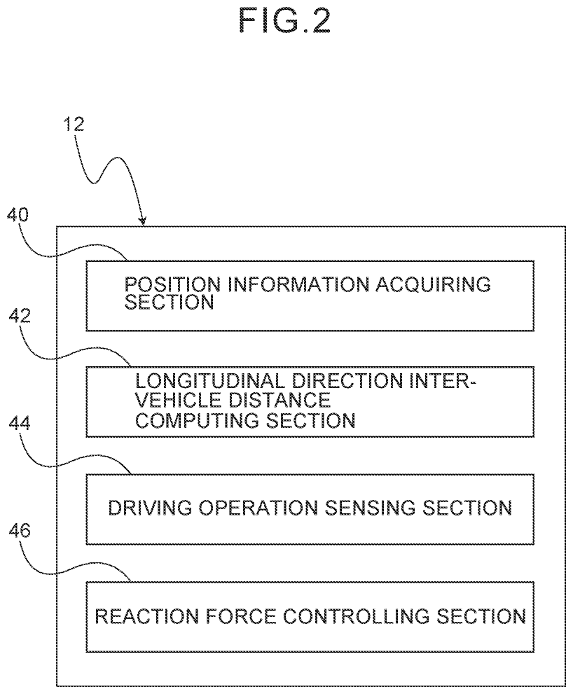

(Functional Structures of Vehicle Control Device 12) The vehicle control device 12 realizes various functions by using the hardware resources illustrated in FIG. 1. The functional structures realized by the vehicle control device 12 are described with reference to FIG. 2.

As illustrated in FIG. 2, the vehicle control device 12 is structured to include, as the functional structures thereof, a position information acquiring section 40, a longitudinal direction inter-vehicle distance computing section 42, a driving operation sensing section 44, and a reaction force controlling section 46. Note that these respective functional structures are realized by the CPU 20 reading-out a program stored in the ROM 22 or the storage 26, and executing the program.

The position information acquiring section 40 acquires position information of the preceding vehicle that travels in front of the host vehicle. Specifically, the position information acquiring section 40 acquires position information of the preceding vehicle on the basis of information sensed by the forward sensor 34.

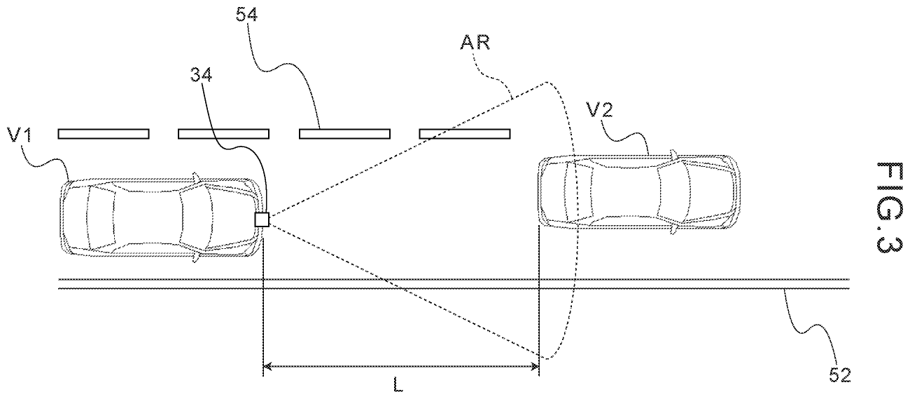

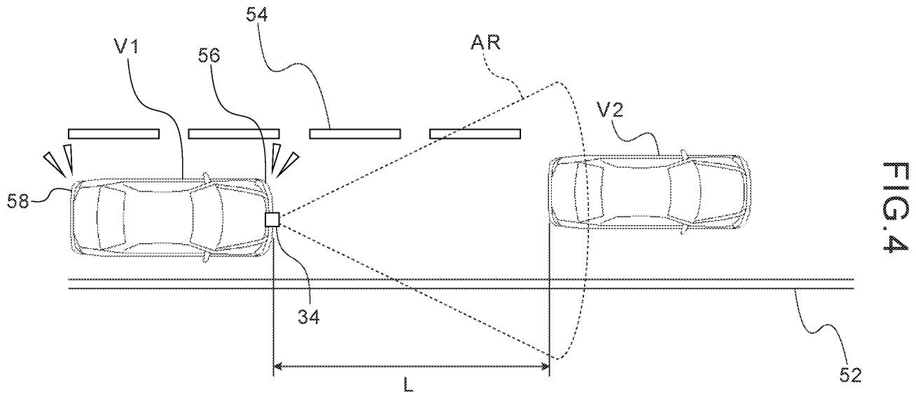

FIG. 3 illustrates a situation in which preceding vehicle V2 is traveling in the same lane as the lane in which host vehicle V1 is traveling. As illustrated in FIG. 3, in a case in which the preceding vehicle V2 is traveling as an obstacle in sensing range AR of the forward sensor 34 that is provided at the front portion of the host vehicle V1, position information of the preceding vehicle V2 is acquired by the position information acquiring section 40. Note that the size of the forward sensor 34 is illustrated in an exaggerated manner in FIG. 3 and FIG. 4 for convenience of explanation. Further, reference numeral 52 in the drawings indicates the center line, and reference numeral 54 in the drawings indicates the lane boundary line.

As illustrated in FIG. 2, the longitudinal direction inter-vehicle distance computing section 42 computes the inter-vehicle distance in the longitudinal direction between the host vehicle V1 and the preceding vehicle V2. Specifically, on the basis of information acquired from the forward sensor 34 by the function of the position information acquiring section 40, the longitudinal direction inter-vehicle distance computing section 42 computes the inter-vehicle distance in the longitudinal direction between the host vehicle V1 and the preceding vehicle V2. As an example, in FIG. 3, distance L from the front end of the host vehicle V1 to the rear end of the preceding vehicle V2 is computed as the inter-vehicle distance in the longitudinal direction.

The driving operation sensing section 44 senses predetermined driving operations that are carried out by the driver. Specifically, the driving operation sensing section 44 senses, as the predetermined driving operations, an intentional acceleration operation of the driver and an intentional lane change operation by the driver.

For example, the driving operation sensing section 44 senses that an intentional acceleration operation is carried out, by acquiring a signal of the degree of opening from the accelerator pedal 36 such as in a case in which the driver increasingly depresses the accelerator pedal 36 or the like. Further, for example, the driving operation sensing section 44 senses that a driving operation relating to a lane change is carried out by the driver in a case in which the driver turns either of the left or right turn signal switches 38 on.

In the present embodiment, as an example, considering the image information that is captured by the forward camera that captures images of the region ahead of the vehicle 10, in a case in which there exists an adjacent lane, it may be sensed that a driving operation relating to a lane change is carried out if the turn signal switch 38 for the direction of the adjacent lane is turned on.

The reaction force controlling section 46 illustrated in FIG. 2 controls the reaction force application mechanism that applies reaction force to the accelerator pedal 36.

Specifically, in a case in which the inter-vehicle distance L in the vehicle longitudinal direction between the host vehicle V1 and the preceding vehicle V2 that is computed by the function of the longitudinal direction inter-vehicle distance computing section 42 is greater than or equal to a predetermined threshold value, the reaction force controlling section 46 does not apply reaction force to the accelerator pedal 36.

Further, in a case in which the inter-vehicle distance L in the longitudinal direction between the host vehicle V1 and the preceding vehicle V2 that is computed by the function of the longitudinal direction inter-vehicle distance computing section 42 is less than the predetermined threshold value, the reaction force controlling section 46 applies reaction force to the accelerator pedal 36 as a rule. In the present embodiment, as an example, in a case in which the preceding vehicle V2 enters into the sensing range AR of the forward sensor 34, the reaction force controlling section 46 applies reaction force to the accelerator pedal 36. Further, the reaction force controlling section 46 controls the reaction force application mechanism 37 such that, the smaller the inter-vehicle distance in the longitudinal direction between the host vehicle V1 and the preceding vehicle V2 becomes, the more the reaction force that is applied to the accelerator pedal 36 increases.

Moreover, in the state in which reaction force is being applied to the accelerator pedal 36, at the time of a predetermined driving operation by the driver, the reaction force controlling section 46 controls the reaction force application mechanism such that the reaction force applied to the accelerator pedal 36 decreases.

A situation in which the host vehicle V1 will overtake the preceding vehicle V2 is illustrated in FIG. 4. As illustrated in FIG. 4, due to the driver turning the left turn signal switch 38 on, a front left turn signal lamp 56 and a rear left turn signal lamp 58 of the host vehicle V1 flash. Here, in a situation in which there is another lane adjacent at the left of the lane in which the host vehicle V1 is traveling, the driving operation sensing section 44 senses that a driving operation relating to a lane change is carried out. In this case, the reaction force controlling section 46 controls the reaction force application mechanism such that the reaction force applied to the accelerator pedal 36 decreases.

In addition, in a case in which an intentional acceleration operation by the driver is sensed by the driving operation sensing section 44, the reaction force controlling section 46 controls the reaction force application mechanism such that the reaction force applied to the accelerator pedal 36 decreases.

Note that, if the inter-vehicle distance L in the longitudinal direction between the host vehicle V1 and the preceding vehicle V2 is less than or equal to a distance that is set as an acceleration prohibited region in which the inter-vehicle distance L is lower than a threshold value, a safety assist device operates, and control of the reaction force by the reaction force controlling section 46 is not carried out. Namely, in the acceleration prohibited region, the reaction force controlling section 46 does not reduce the reaction force even if a predetermined driving operation by the driver is sensed.

(Operation)

Operation of the present embodiment is described next.

(Vehicle Control Processing)

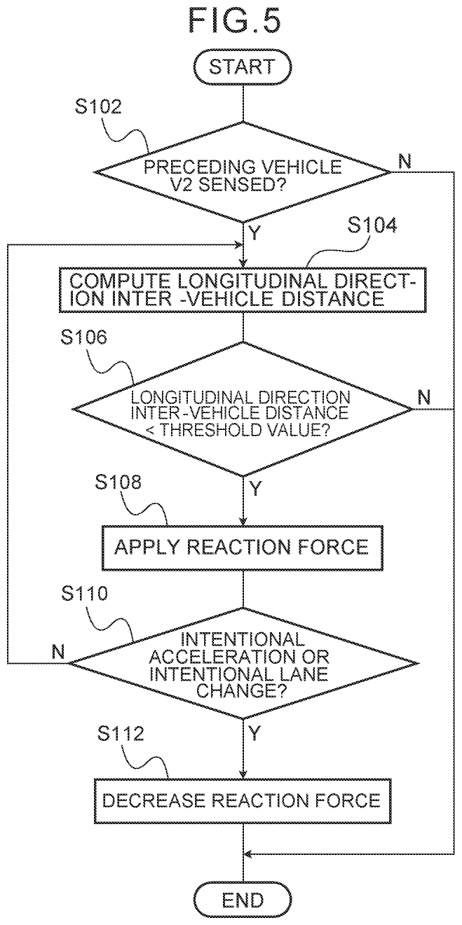

FIG. 5 is a flowchart illustrating an example of the flow of vehicle control processing by the vehicle control device 12 relating to the present embodiment. Note that this vehicle control processing is executed due to the CPU 20 reading-out a program from the storage 26 and expanding the program in the RAM 24.

As illustrated in FIG. 5, in step S102, the CPU 20 determines whether or not the preceding vehicle V2 has been sensed. Specifically, if the preceding vehicle V2 has been sensed by the forward sensor 34, the determination in step S102 is affirmative, and the CPU 20 moves on to the processing of step S104. On the other hand, if the preceding vehicle V2 has not been sensed by the forward sensor 34, the CPU 20 ends the vehicle control processing.

In step S104, the CPU 20 computes the inter-vehicle distance in the longitudinal direction between the host vehicle V1 and the preceding vehicle V2.

In step S106, the CPU 20 determines whether or not the inter-vehicle distance in the longitudinal direction is less than the threshold value. If the inter-vehicle distance in the longitudinal direction between the host vehicle V1 and the preceding vehicle V2 is less than the threshold value, the CPU 20 moves on to the processing of step S108. If the inter-vehicle distance in the longitudinal direction is greater than or equal to the threshold value, the CPU 20 ends the vehicle control processing without applying reaction force to the accelerator pedal 36.

In step S108, the CPU 20 applies reaction force to the accelerator pedal 36.

Specifically, the CPU 20 applies a predetermined reaction force to the accelerator pedal 36 by operating the reaction force application mechanism 37 by the function of the reaction force controlling section 46.

In step S110, the CPU 20 determines whether or not intentional acceleration or an intentional lane change has been sensed. Specifically, if, by acquiring a signal of the degree of opening from the accelerator pedal 36 by the function of the driving operation sensing section 44, the CPU 20 senses that an intentional acceleration operation is carried out, the CPU 20 moves on to the processing of step S112. Further, if, by the function of the driving operation sensing section 44, the CPU 20 senses that either of the left or right turn signal switches 38 has been turned on, and there is a lane in the direction of the turned-on turn signal switch 38 with respect to the host vehicle V1, the CPU 20 senses that an intentional lane change operation is carried out, and moves on to the processing of step S112.

On the other hand, in step S110, if the CPU 20 does not sense either of intentional acceleration or an intentional lane change, the CPU 20 returns to the processing of step S104, and computes the inter-vehicle distance in the longitudinal direction.

In step S112, the CPU 20 decreases the reaction force that is applied to the accelerator pedal 36. Specifically, the CPU 20 decreases the reaction force applied to the accelerator pedal 36 by controlling the reaction force application mechanism 37 by the function of the reaction force controlling section 46.

As described above, at the vehicle control device 12 relating to the present embodiment, the reaction force application mechanism 37 that applies reaction force to the accelerator pedal 36 is controlled on the basis of the inter-vehicle distance L between the host vehicle V1 and the preceding vehicle V2, and a predetermined operation by the driver. In this way, not only is the reaction force application mechanism 37 controlled on the basis of the inter-vehicle distance L between the host vehicle V1 and the preceding vehicle V2, but also, the reaction force that is applied to the accelerator pedal 36 is changed while taking a predetermined driving operation by the driver into consideration. Due thereto, the application of reaction force to the accelerator pedal 36 can be suppressed in situations such as cases in which the driver wishes to overtake the preceding vehicle, and the like.

Further, in the present embodiment, reaction force is applied to the accelerator pedal 36 by the reaction force application mechanism 37 in a case in which the inter-vehicle distance L in the longitudinal direction between the host vehicle V1 and the preceding vehicle V2 is less than a threshold value. Due thereto, the driver can be warned of approaching the preceding vehicle V2. Further, in the state in which reaction force is being applied, at the time of a predetermined driving operation by the driver, the reaction force application mechanism 37 is controlled such that the reaction force applied to the accelerator pedal 36 decreases. Due thereto, driving is not hampered in cases in which the driver wishes to accelerate.

Moreover, in the present embodiment, by decreasing the reaction force of the accelerator pedal 36 in case in which a driving operation relating to acceleration is carried out by the driver, control that takes the intent of the driver into consideration can be carried out, and the comfort can be improved. In particular, by determining that a driving operation is carried out in a case in which increasing depression of the accelerator pedal 36 is sensed as in the present embodiment, the reaction force application mechanism 37 can be controlled while reflecting the intent of the driver to accelerate.

Still further, in the present embodiment, by decreasing the reaction force of the accelerator pedal 36 in a case in which a driving operation relating to a lane change is carried out by the driver, control that takes the intent of the driver into consideration can be carried out, and the comfort can be improved. In particular, by determining that there is the intent to change lanes in a case in which the turn signal switch 38 is turned on as in the present embodiment, the reaction force application mechanism 37 can be controlled while reflecting the intent of the driver to avoid the preceding vehicle.

Although the vehicle control device 12 relating to the embodiment has been described above, the present disclosure can, of course, be implemented in various forms within a scope that does not depart from the gist thereof. For example, the reaction force application mechanism 37 of the present embodiment is structured to apply an arbitrary reaction force to the accelerator pedal by causing a predetermined torque to be generated from a servo motor, but may apply reaction force to the accelerator pedal by another mechanism. For example, reaction force may be applied to the accelerator pedal by a mechanism using a cylinder and hydraulic pressure, or the like.

Further, in the above-described embodiment, it is sensed that a driving operation relating to a lane change is carried out in a case in which the turn signal switch 38 in the direction of an adjacent lane is turned on. However, the present disclosure is not limited to this. For example, the reaction force that is applied to the accelerator pedal 36 may be decreased in a case in which the turn signal switch 38 is turned on in the state in which reaction force is being applied to the accelerator pedal 36, regardless of the existence of an adjacent lane.

Moreover, there may be a structure in which the reaction force applied to the accelerator pedal 36 is decreased in a case in which both an intentional acceleration operation and an intentional lane change operation by the driver are sensed.

In the above-described embodiment, the driving operation sensing section 44 determines that a driving operation relating to a lane change is carried out, on the basis of information from the turn signal switch 38. However, the present disclosure is not limited to this. For example, the lane in which the host vehicle V1 is traveling may be imaged by the forward camera, and it may be determined that a driving operation relating to a lane change is carried out in a case in which it is determined, from the captured image information, that the host vehicle V1 is straddling the lane boundary line 54.

Further, in the above-described embodiment, the reaction force controlling section 46 controls the reaction force application mechanism such that, in an applied state in which reaction force is applied to the accelerator pedal 36, the reaction force that is applied to the accelerator pedal 36 is decreased to a predetermined magnitude at the time of a predetermined driving operation by the driver. However, the present disclosure is not limited to this. For example, the extent of decreasing the reaction force applied to the accelerator pedal 36 may be changed in accordance with the inter-vehicle distance L between the host vehicle V1 and the preceding vehicle V2. Namely, in a case in which the inter-vehicle distance L is relatively large, the reaction force controlling section 46 may decrease all at once the reaction force applied to the accelerator pedal 36, and, in a case in which the inter-vehicle distance L is relatively small, the reaction force controlling section 46 may gradually decrease the reaction force applied to the accelerator pedal 36.

Further, any of various types of processors other than the CPU 20 may execute the processing that are executed due to the CPU 20 reading-in programs in the above-described embodiment. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processing such as ASICs (Application Specific Integrated Circuits) and the like, and the like. Further, the respective processing may be executed by one of these various types of processors, or may be executed by a combination of two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like.

The above embodiment describes a form in which the respective programs are stored in advance (are installed) on a non-transitory, computer-readable storage medium. However, the present disclosure is not limited to this, and the respective programs may be provided in forms of being recorded on a non-transitory storage medium such as a CD-ROM (Compact Disc Read Only Memory), a DVD-ROM (Digital Versatile Disc Read Only Memory), a USB (Universal Serial Bus) memory, or the like. Further, the programs may be in forms of being downloaded from an external device over a network.

Moreover, the flow of processing described in the above embodiment are an example, and unnecessary steps may be deleted therefrom, new steps may be added thereto, or the order of processing may be rearranged, within a scope that does not depart from the gist of the present disclosure.

What is claimed is:

1. A vehicle control device, comprising a processor, wherein the processor is configured to control a reaction force application mechanism, which applies reaction force to an accelerator pedal, based on a predetermined driving operation by a driver.

2. The vehicle control device of claim 1, wherein the processor controls the reaction force application mechanism so as to effect an applied state in which reaction force is applied to the accelerator pedal in a case in which an inter-vehicle distance in a longitudinal direction between a host vehicle and a preceding vehicle traveling in front of the host vehicle is less than a threshold value, and such that, at a time of a the predetermined driving operation by the driver, the reaction force applied to the accelerator pedal decreases.

3. The vehicle control device of claim 2, wherein the processor controls the reaction force application mechanism such that the reaction force applied to the accelerator pedal decreases in a case in which a driving operation relating to acceleration is carried out by the driver.

4. The vehicle control device of claim 3, wherein the processor determines that the driving operation relating to acceleration is carried out based on a degree of depression of the accelerator pedal.

5. The vehicle control device of claim 2, wherein the processor controls the reaction force application mechanism such that the reaction force applied to the accelerator pedal decreases in a case in which a driving operation relating to a lane change is carried out by the driver.

6. The vehicle control device of claim 5, wherein the processor determines that the driving operation relating to a lane change is carried out based on information regarding a turn signal switch.

7. A vehicle, comprising:
a sensor configured to sense a preceding vehicle;
a reaction force application mechanism configured to apply reaction force to an accelerator pedal; and
the vehicle control device of claim 1.

8. A vehicle control method, comprising controlling, based on a predetermined driving operation by a driver, a reaction force application mechanism that applies reaction force to an accelerator pedal.

9. A non-transitory storage medium storing a program executable by a computer to perform processing, the processing comprising controlling, based on a predetermined driving operation by a driver, a reaction force application mechanism that applies reaction force to an accelerator pedal.
